(19) United States
(12) Patent Application Publication
(10) Pub. No.: US 2016/0061728 A1
(43) Pub. Date: Mar. 3, 2016

(54) PLATE-LIKE MEMBER AND MEASUREMENT APPARATUS INCLUDING THE SAME

(71) Applicant: CANON KABUSHIKI KAISHA, Tokyo (JP)

(72) Inventors: Sayuri Yamaguchi, Tokyo (JP); Oichi Kubota, Kawasaki-shi (JP)

(21) Appl. No.: 14/826,941

(22) Filed: Aug. 14, 2015

(30) Foreign Application Priority Data
Aug. 29, 2014 (JP) 2014-176289

(51) Int. Cl. G01N 21/55

(52) U.S. Cl. CPC G01N 21/55

(57) ABSTRACT

A plate-like member includes a sample contact portion that includes first and second surfaces opposite to each other, and a separation portion that includes the first surface and a third surface that is opposite to the first surface. The first surface may receive a terahertz wave, and the second surface may come into contact with a sample during a measurement. The separation portion is configured such that: (i) an acquired time waveform may include only a time waveform of a terahertz wave reflected by the first surface or (ii) a time difference between a first time at which a terahertz wave reflected by the first surface is detected and a second time at which a terahertz wave reflected by the third surface is detected is greater than a time difference between the first time and a time at which a terahertz wave reflected by the second surface is detected.

### BACKGROUND OF THE INVENTION

1. Field of the Invention

The present disclosure relates to plate-like members to be used in measurement apparatuses for measuring time waveforms of terahertz waves and to measurement apparatuses including such plate-like members.

2. Description of the Related Art

Terahertz waves are electromagnetic waves in a frequency band (terahertz waveband) covering at least some frequencies in a range from 30 GHz to 30 THz inclusive. Nowadays, non-destructive sensing techniques using the terahertz waves are being developed. In application fields of such sensing techniques, being developed are a technique in which imaging is carried out with a fluoroscopic apparatus, which is safe and is to replace an X-ray apparatus, a spectroscopic technique in which an absorption spectrum or a complex dielectric constant of the inside of a substance is obtained and information on a sample, such as a coupling state of molecules, is obtained, and so on.

In this manner, terahertz waves are expected to be applied to a variety of application fields, and samples take on a variety of forms. Depending on the form of a given sample, the sample is irradiated with terahertz waves through a plate-like member in a state in which the plate-like member and the sample are in tight contact with each other, and information on the sample is acquired on the basis of a time waveform acquired through the irradiation. For example, when the condition of human tissue is to be examined, it is desirable that reflectometry be carried out after a surface of the human tissue is smoothed by using a plate-like member for reducing roughness on the surface, which can cause terahertz waves to scatter. P. U. Jepsen et al., Optics Express, (2007), 15, 14717-14737 discloses the following method. Specifically, a terahertz wave reflected by a surface of a plate-like member and a terahertz wave reflected by an interface between the plate-like member and a sample are detected, and on the basis of the detection results, a complex refractive index spectrum of the sample, which is in tight contact with the plate-like member, is acquired.

When information on a sample is to be acquired by irradiating the sample with a terahertz wave through a plate-like member and measuring a time waveform of a terahertz wave reflected by the sample, information on the plate-like member that is mixed in the acquired time waveform needs to be separated. Although the method disclosed in P. U. Jepsen et al., Optics Express, (2007), 15, 14717-14737 makes it possible to acquire information on the sample, such as a complex refractive index spectrum, through the plate-like member, information on the plate-like member may be mixed in the acquired information on the sample, and thus the accuracy in the acquired information on the sample may be reduced.

### SUMMARY OF THE INVENTION

According to an aspect of the present disclosure, at least one embodiment of a plate-like member to be used in a measurement apparatus configured to measure a time waveform of a terahertz wave includes a sample contact portion that includes a first surface and a second surface that is opposite to the first surface, and a separation portion that includes the first surface and a third surface that is opposite to the first surface. The first surface is configured to receive a terahertz wave, and the second surface is configured to come into contact with a sample when a measurement is carried out. The separation portion is configured such that a time waveform acquired as the measurement apparatus irradiates the separation portion with a terahertz wave includes only a time waveform of a terahertz wave reflected by the first surface or such that a time difference between a time at which a terahertz wave reflected by the first surface is detected and a time at which a terahertz wave reflected by the third surface is detected is greater than a time difference between the time at which the terahertz wave reflected by the first surface is detected and a time at which a terahertz wave reflected by the second surface is detected.

According to other aspects of the present disclosure, one or more additional plate-like members, and one or more measurement apparatuses including the same are discussed herein. Further features of the present disclosure will become apparent from the following description of exemplary embodiments with reference to the attached drawings.

### BRIEF DESCRIPTION OF THE DRAWINGS

FIG. 1 illustrates an overview of a plate-like member according to a first exemplary embodiment.

FIG. 2A is an illustration for describing a time waveform of a terahertz wave in a control sample contact portion of the plate-like member according to the first exemplary embodiment.

FIG. 2B is an illustration for describing a time waveform of a terahertz wave in a sample contact portion of the plate-like member according to the first exemplary embodiment.

FIG. 2C is an illustration for describing a time waveform of a terahertz wave in a separation portion of the plate-like member according to the first exemplary embodiment.

FIG. 3 is a flowchart of an information acquisition method in which the plate-like member according to an exemplary embodiment of the present invention is used.

FIG. 4 illustrates a configuration of a measurement apparatus according to the first exemplary embodiment.

FIG. 5 illustrates an overview of a plate-like member according to a second exemplary embodiment.

FIG. 6A is an illustration for describing a relation between an inclination in the plate-like member and the angle of incidence of a terahertz wave in a case in which a third surface is inclined in the same direction as the direction in which the terahertz wave is incident and the terahertz wave starts being totally reflected from the back surface of the plate-like member according to the second exemplary embodiment.

FIG. 6B is an illustration for describing a relation between an inclination in the plate-like member and the angle of incidence of a terahertz wave in a case in which the third surface is inclined in the same direction as the direction in which the terahertz wave is incident and the terahertz wave starts being totally reflected from the front surface of the plate-like member according to the second exemplary embodiment.

FIG. 7 illustrates an overview of a plate-like member according to a third exemplary embodiment.

FIG. 8A illustrates a time waveform acquired in the control sample contact portion in a first implementation example.

FIG. 8B illustrates a time waveform acquired in the sample contact portion in the first implementation example.

FIG. 8C illustrates a time waveform acquired in the separation portion in the first implementation example.

FIG. 9A illustrates a refractive index spectrum acquired in the first implementation example.

FIG. 9B illustrates an absorption coefficient spectrum acquired in the first implementation example.

FIG. 10A illustrates a refractive index spectrum of a section of a rat brain in a second implementation example.

FIG. 10B illustrates refractive index spectra of a normal region and a tumor region in the section of the rat brain in the second implementation example.

FIG. 11 illustrates a sample in the second implementation example.

FIG. 12A is an illustration for describing a relation between an inclination in the plate-like member and the angle of incidence of a terahertz wave in a case in which a third surface is inclined in a direction different from the direction in which the terahertz wave is incident and the terahertz wave starts being totally reflected from the back surface of the plate-like member according to the second exemplary embodiment.

FIG. 12B is an illustration for describing a relation between an inclination in the plate-like member and the angle of incidence of a terahertz wave in a case in which a third surface is inclined in a direction different from the direction in which the terahertz wave is incident and the terahertz wave starts being totally reflected from the front surface of the plate-like member according to the second exemplary embodiment.

FIG. 13A is an illustration for describing a relation between the direction in which a terahertz wave is incident and a first surface according to the second exemplary embodiment.

FIG. 13B is an illustration for describing another example of the relation between the direction in which a terahertz wave is incident and the first surface according to the second exemplary embodiment.

### DESCRIPTION OF THE EMBODIMENTS

Exemplary embodiments described hereinafter are directed to improving the accuracy in the acquired information on a sample in a measurement apparatus that acquires information on the sample by measuring a time waveform of a terahertz wave reflected by the sample. The measurement apparatus is a reflective terahertz time-domain spectroscopy (THz-TDS) apparatus that acquires a time waveform of a terahertz wave reflected by a sample.

Information on a sample as used herein includes the shape of an object in the sample, the shape of a region in the sample that has predetermined optical characteristics, and the optical characteristics of the sample. The optical characteristics as used herein is defined to include a complex amplitude reflectance, a complex refractive index, a complex dielectric constant, a reflectance, a refractive index, an absorption coefficient, a dielectric constant, an electrical conductivity, and so on of the sample.

With the use of the measurement apparatus, information on a sample can be acquired on the basis of a time waveform of the sample that is in contact with the plate-like member. When the information on a sample is to be acquired, a terahertz wave (second reflection pulse), appearing in the acquired time waveform, that has been reflected by an interface (second surface) between the plate-like member and the sample is separated from a terahertz wave (first reflection pulse), appearing in the acquired time waveform, that has been reflected by a front surface (first surface) of the plate-like member and is then used. However, although the first reflection pulse component attenuates with time after the peak of the pulse, the component does not attenuate completely, and a residual component of the first reflection pulse is present even when the second reflection pulse is to be detected.

In order to remove the residual component of the first reflection pulse that is included in the second reflection pulse and that can cause the accuracy in acquiring the physical properties to decrease, a time waveform in which the second reflection pulse is temporally or spatially separated from the first reflection pulse is used. Exemplary embodiments described hereinafter are implemented by a plate-like member that, in order to acquire a time waveform in which the second reflection pulse is temporally or spatially separated from the first reflection pulse, includes a portion for acquiring the first reflection pulse and the second reflection pulse within an identical time waveform and another portion for acquiring only the first reflection pulse.

As described above, the first reflection pulse component, which is a reflection wave from the front surface of the plate-like member, attenuates with time after the peak of the pulse. However, when the plate-like member is thin and the first reflection pulse and the second reflection pulse are temporally close to each other, the intensity of the attenuating component of the first reflection pulse is high, which may affect the shape of the second reflection pulse. Therefore, it is desirable that the plate-like member be thick enough so that the residual component of the first reflection pulse does not affect the shape of the second reflection pulse but also be thin.

A reason why a thin plate-like member is used when a time waveform is acquired through the plate-like member is related to the depth of focus of a terahertz wave. In the exemplary embodiments described hereinafter, employed is a technique in which, with the first reflection pulse from the front surface of the plate-like member serving as a reference signal, the physical properties of the sample that are included in the second reflection pulse from the interface between the plate-like member and the sample are acquired. In order to acquire the physical properties with high accuracy, it is necessary that each of the interfaces where the first reflection pulse and the second reflection pulse are generated be present within the depth of focus, which is a region where it is considered that the terahertz waves propagate in parallel. In other words, it is necessary that the plate-like member have a thickness such that both surfaces of the plate-like member are in a region within the depth of focus.

The depth of focus is determined by the beam diameter of a beam waist at the focal point, the beam diameter held prior to being focused, and the focal length of a condenser lens. When an image of a sample, such as biological tissue, having nonuniformly distributed optical characteristics is to be acquired, it is desirable that the beam diameter at the focal point be approximately 1 mm or less. In this case, the depth of focus is approximately 1-2 mm, for example, in a reflective THz-TDS apparatus in which the beam diameter held prior to being focused is 1 inch (25.4 mm) and the focal length is 5 inches (127 mm). By setting the beam diameter held prior to being focused to be smaller or by setting the focal length of the condenser lens to be greater, the depth of focus can be increased and adjusted to a several millimeters.

Although it is possible to set the thickness of the plate-like member to be greater as long as the thickness falls within the depth of focus, as the plate-like member is thicker, the influence of the optical characteristics of the plate-like member included in the second reflection pulse becomes greater. In addition, as the plate-like member is thicker, the spatial discrepancy between the first reflection pulse and the second reflection pulse becomes greater. Thus, deviations occur in the positions on a detector on which the first reflection pulse and the second reflection pulse are incident, and the accuracy in the acquired information is degraded. Furthermore, as the plate-like member is thicker, a time difference between the time at which the first reflection pulse is detected and the time at which the second reflection pulse is detected becomes greater. When the information is acquired, it is necessary to set the same number of data points for the first reflection pulse and the second reflection pulse, and thus the overall sweep time for acquiring a time waveform increases, and the measurement time increases as a result. When a case in which a two-dimensional image of a sample that is in tight contact with the plate-like member is to be acquired or a case in which a sample that is susceptible to degradation with time is to be measured is considered, it is preferable that the measurement time be short.

On the basis of the above, it is desirable that the plate-like member be thin and the thickness thereof be no greater than the depth of focus and approximately several millimeters at most. Specifically, when an adjustment of the depth of focus in an optical system in a typical reflective THz-TDS apparatus is taken into consideration, it is desirable that the thickness be, in an optical length, from 0.5 mm to 3 mm inclusive. Hereinafter, a plate-like member that, in order to acquire a time waveform in which the second reflection pulse is temporally or spatially separated from the first reflection pulse, includes a portion for acquiring the first reflection pulse and the second reflection pulse within the same time waveform and another portion for obtaining only the first reflection pulse will be described in concrete terms.

### First Exemplary Embodiment

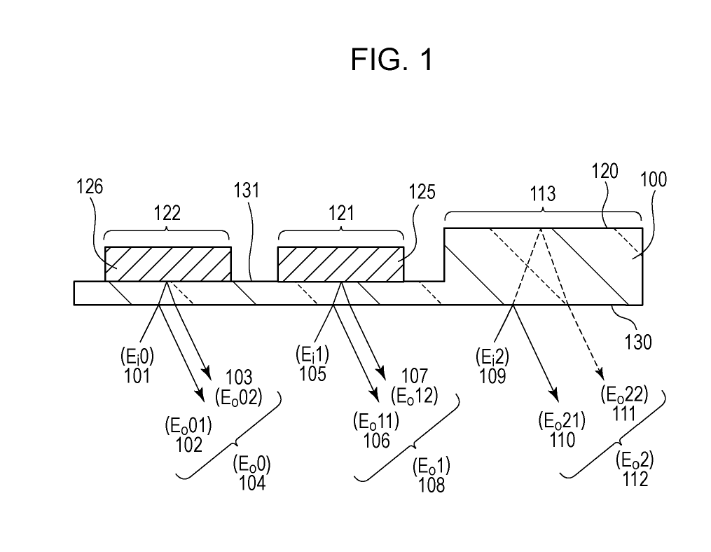

A plate-like member 100 (hereinafter, referred to as the object 100) according to a first exemplary embodiment will be described with reference to FIG. 1. FIG. 1 illustrates an overview of the plate-like member 100. The plate-like member 100 is preferably made of a material that highly transmits terahertz waves and whose physical properties are stable and known. Specifically, the plate-like member 100 may be constituted by a quartz substrate, a single-crystal silicon substrate, or the like. The object 100 includes a sample contact portion 121 (hereinafter, referred to as a first contact portion 121), a control sample contact portion 122 (hereinafter, referred to as a second contact portion 122), and a separation portion 113.

The first contact portion 121 is a region that makes contact with a sample 125. The second contact portion 122 is a region that makes contact with a control sample 126. The first contact portion 121 and the second contact portion 122 each include a first surface 130 on which a terahertz wave is incident and a second surface 131 that makes contact with the sample 125 or the control sample 126. The first surface 130 and the second surface 131 are opposite to each other. A solid, a liquid, or a gas whose physical properties are known is used as the control sample 126. A time waveform of a terahertz wave 104 reflected by the control sample 126 is also used to acquire information on the sample 125. A detailed description will be given later.

The thickness of the object 100 at the first contact portion 121 and the second contact portion 122 is uniform. In addition, it is desirable that the sample 125 and the control sample 126 be in tight contact with the second surface 131 with no space therebetween. When it is difficult to bring the sample 125 or the control sample 126 to be in tight contact with the second surface 131, a matching liquid having a refractive index that is close to the refractive index of the object 100, the sample 125, or the control sample 126 may be applied on an interface so as to improve the adhesion. In the present specification, even in a case in which a matching liquid is applied on the interface between the second surface 131 and the sample 125 or the control sample 126, it is considered that the second surface 131 is in contact with the sample 125 or the control sample 126. When a measurement is carried out while the object 100 is held in the air, the air may be used as the control sample 126, but the humidity and the temperature of the air are liable to change depending on the surrounding environment and are unstable. Therefore, in order to further improve the accuracy in the acquired information, it is desirable that the control sample 126 be a material whose physical properties are stable and known.

The separation portion 113 is a region for separating the second reflection pulse from the first reflection pulse. In the present exemplary embodiment, in order to temporally separate the second reflection pulse from the first reflection pulse, the object 100 is thicker at the separation portion 113 than at the first contact portion 121 and the second contact portion 122. Specifically, the separation portion 113 includes the first surface 130 and a third surface 120 that is opposite to the first surface 130, and is configured such that the distance between the first surface 130 and the third surface 120 is greater than the distance between the first surface 130 and the second surface 131.

Consequently, the time difference between the time at which a terahertz wave reflected by the first surface 130 is detected and the time at which a terahertz wave reflected by the third surface 120 is detected is greater than the time difference between the time at which a terahertz wave reflected by the first surface 130 is detected and the time at which a terahertz wave reflected by the second surface 131 is detected. Therefore, depending on the length of the time axis of a time waveform, a time waveform acquired by irradiating the separation portion 113 with a terahertz wave includes only a time waveform of a terahertz wave reflected by the first surface 130.

Hereinafter, a process of calculating a complex refractive index, which serves as the information on the sample 125, on the basis of a measurement result acquired from reflectometry of a terahertz wave with the use of the object 100 will be described. In the measurement of a time waveform, a terahertz wave is made incident on the object 100 on a side that is opposite to the surface on which the sample 125 is disposed. In the present specification, the surface (second surface) 131 of the object 100 on which the sample 125 is disposed may be referred to as the back surface of the object 100, and the surface opposite to the back surface, or in other words, the surface (first surface) 130 that a terahertz wave reaches first may be referred to as the front surface of the object 100.

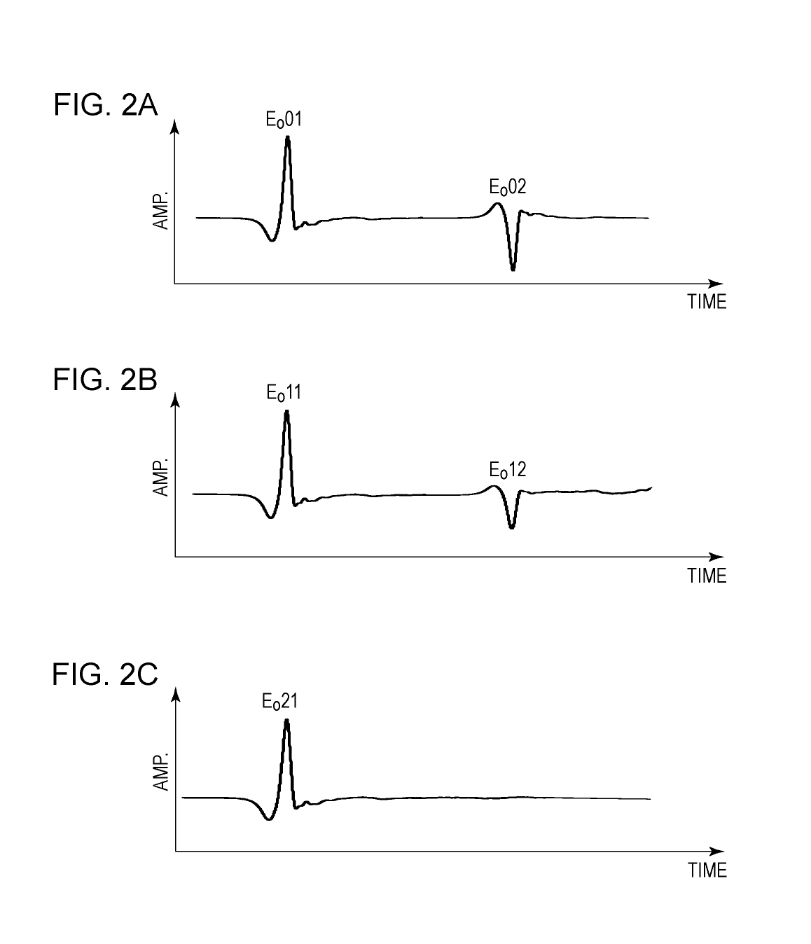

A pulsed terahertz wave (incident wave) 101 (Eᵢ0) is made incident on the second contact portion 122, and a reflection wave 104 (E₀0) is obtained. The reflection wave 104 includes a reflection wave 102 (E₀01) reflected by the front surface of the object 100, a reflection wave 103 (E₀02) reflected once by an interface between the object 100 and the control sample 126, and a group of reflection waves (not illustrated) reflected twice or more within the object 100. FIG. 2A illustrates an acquired time waveform. Such a time waveform acquired by measuring the second contact portion 122 is used to obtain the information that will be described later, but a time waveform of a terahertz wave reflected by the object 100 that has been irradiated with a terahertz wave before the sample 125 is disposed on the object 100 so as to be in tight contact with the first contact portion 121 may be substituted for the aforementioned time waveform.

Subsequently, the first contact portion 121 that is in tight contact with the sample 125 is irradiated with an incident wave 105 (Eᵢ1), and a reflection wave 108 (E₀1) is obtained. The reflection wave 108 includes a reflection wave 106 (E₀11) reflected by the front surface of the object 100, a reflection wave 107 (E₀12) reflected once by an interface between the object 100 and the sample 125, and a group of reflection waves (not illustrated) reflected twice or more within the object 100. FIG. 2B illustrates an acquired time waveform.

Furthermore, the separation portion 113 is irradiated with an incident wave 109 (Eᵢ2), and a reflection wave 112 (E₀2) is obtained. The separation portion 113 is sufficiently thicker than the first contact portion 121 and the second contact portion 122 so that a residual component of a reflection wave 110 (E₀21) from the front surface of the object 100 is not superimposed on a reflection wave 111 (E₀22) from the back surface of the object 100. Therefore, as illustrated in FIG. 2C, when a time waveform is acquired with the same number of measurement points and for the same time domain as those for the first contact portion 121 and the second contact portion 122, the reflection wave 111 (E₀22) does not appear in the time waveform, and only the reflection wave 110 (E₀21) from the front surface of the object 100 is obtained.

A complex amplitude reflectance \tilde{r}_{WSa} of the sample 125 from the object 100 to the sample 125 at a position in the vicinity of a position irradiated with the terahertz wave is obtained by cutting out, from the reflection wave 108, a portion derived from the reflection wave 106 and a portion derived from the reflection wave 107 and by comparing these portions. At this point, by cutting out, from the reflection wave 104, a portion derived from the reflection wave 102 and a portion derived from the reflection wave 103 and by using these portions in a similar manner, an influence arising as the sample 125 is measured by being irradiated with a terahertz wave through the object 100 is removed. Specifically, the aforementioned influence includes a phase difference between the reflection waves 107 and 106 arising as the reflection wave 107 has traveled back and forth within the object 100 having a thickness d, and a discrepancy between a position on a detection unit on which the reflection wave 106 is incident and a position on the detection unit on which the reflection wave 107 is incident.

In the present specification, “\tilde{r}” in expressions and “ñ” in expressions appearing later indicate that they are complex numbers.

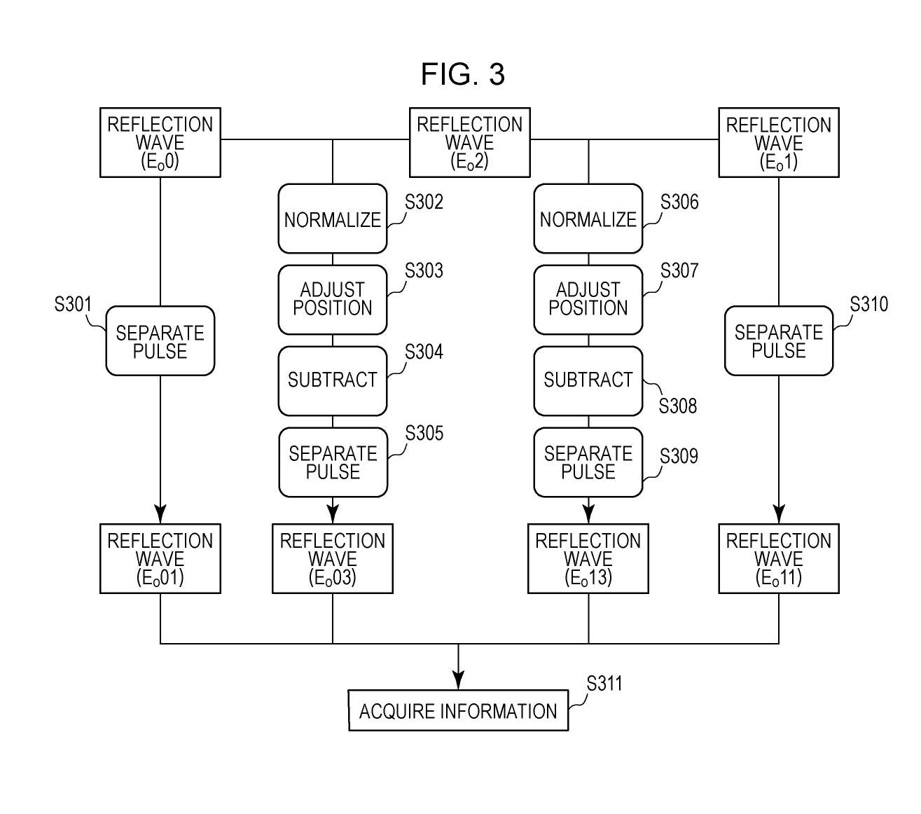

When a portion corresponding to the reflection wave 106 and a portion corresponding to the reflection wave 107 are to be cut out from the reflection wave 108, if these portions are cut out in a state in which a residual component of the reflection wave 106 is contained in the reflection wave 107, the accuracy in the acquired information decreases. In a similar manner, when a portion corresponding to the reflection wave 102 and a portion corresponding to the reflection wave 103 are to be cut out from the reflection wave 104, if these portions are cut out in a state in which a residual component of the reflection wave 102 is contained in the reflection wave 103, the accuracy in the acquired information decreases. Therefore, the reflection wave 112 is used in order to remove the residual components of the reflection waves 102 and 106 reflected by the front surface of the object 100. A series of specific procedures is illustrated in FIG. 3.

The peak intensity of the reflection wave 112 is normalized by the peak intensity of the reflection wave 102 (S302), and the positions of the peaks on the time axis are also matched (S303). Thereafter, the normalized reflection wave 112 is subtracted from the time waveform of the reflection wave 104 (S304), and a portion corresponding to a reflection wave E₀03 obtained by removing a residual component from the time waveform of the reflection wave 103 is cut out (S305). The reflection wave 102 is separately cut out from the time waveform of the reflection wave 104 before the normalized reflection wave 112 is subtracted (S301).

In a similar manner, the peak intensity of the reflection wave 112 is normalized by the peak intensity of the reflection wave 106 (S306), and the positions of the peaks on the time axis are also matched (S307). Thereafter, the normalized reflection wave 112 is subtracted from the reflection wave 108 (S308), and a reflection wave E₀13 obtained by removing a residual component from the time waveform of the reflection wave 107 is cut out (S309). The reflection wave 106 is separately cut out from the time waveform of the reflection wave 108 before the normalized reflection wave 112 is subtracted (S310).

In each of the cut-out time waveforms, the signal has not attenuated at the starting point and the ending point of the cutout, and when the signal intensity at the starting point differs from the signal intensity at the ending point, the intensities appear in a spectrum as a low frequency component when the signal is later subjected to the Fourier transform in signal processing. To prevent such a situation, it is desirable that the signal intensity be attenuated at the starting point and the ending point of the cutout by using a window function so that the starting point and the ending point of the cutout smoothly connect to each other when the identical time waveforms are arranged adjacently.

The reflection wave 106 and the reflection wave E₀13 in the first contact portion 121 and the reflection wave 104 and the reflection wave E₀03 in the second contact portion 112 obtained thus far are each subjected to the Fourier transform. By using each of the obtained Fourier transform signals, the complex amplitude reflectance \tilde{r}_{WSa} is expressed through Expression (1). Expression (1) is applied when the difference between the thickness d of the first contact portion 121 and the thickness d of the second contact portion 122 of the object 100 is negligibly small. F[E_{*}] represents the Fourier transform of a time waveform E_{*}. For example, F[E₀₁₁] is a Fourier transform signal of a time waveform of the reflection wave 106 (E₀11) from the front surface of the object 100 that has been cut out from the reflection wave 108.

$${\tilde{r}}_{WSa} ( ω ) = {\tilde{r}}_{WSt} \cdot ( \frac{F [ {E}_{O 13} ]}{F [ {E}_{O 11} ]} / \frac{F [ {E}_{O 03} ]}{{E}_{O 01}} ) \qquad ( 1 )$$

The expression \tilde{r}_{WSt} on the right-hand side is a complex amplitude reflectance of a terahertz wave traveling from the plate-like member to the control sample 126, and is given by Expression (2) from the complex refractive index ñ_{W} of the object 100 and the complex refractive index ñ_{St} of the control sample 126.

\tilde{r}_{WSt}(ω)=(ñ_{W}−ñ_{St})/(ñ_{W}+ñ_{St}) (2)

When a measurement is carried out in the air with no sample in contact with the second contact portion 122, the complex amplitude reflectance \tilde{r}_{WSt} of a terahertz wave traveling from the object 100 to the control sample 126 is given by Expression (3) using the complex refractive index ñ_{W} of the object 100. In this case, when \tilde{r}_{WSt} in Expression (1) is replaced with \tilde{r}_{WA}, \tilde{r}_{WSa} is obtained.

\tilde{r}_{WA}(ω)=(ñ_{W}−1)/(ñ_{W}+1) (3)

The complex refractive index ñ_{Sa} of the sample 125 itself is obtained from the complex amplitude reflectance \tilde{r}_{WSa} of a terahertz wave traveling from the object 100 to the sample 125 that is in tight contact with the second surface 131 and the complex refractive index ñ_{W} of the plate-like member obtained in the above-described manner.

ñ_{Sa}(ω)=ñ_{W}·(1−\tilde{r}_{WSa})/(1+\tilde{r}_{WSa}) (4)

In the measurement in which the object 100 according to the present exemplary embodiment is used, a reflective THz-TDS apparatus 400 that includes a support portion 407 for supporting the object 100 is used. As the support portion 407 or a mechanism for moving a terahertz wave optical system is additionally provided, the complex refractive indices can be obtained at a plurality of points in the sample 125 that is in tight contact with the first contact portion 121. When a sample having nonuniformly distributed complex refractive indices is measured with such a mechanism, an image representing the distribution of the values of the complex refractive indices can be acquired. In this case, intensity modulation of a terahertz wave caused by intensity modulation or the like of a laser beam outputted by a light source 401 is obtained in the form of intensity modulation of the reflection wave 106 obtained in the first contact portion 121. Therefore, the second contact portion 122 and the separation portion 113 do not need to be measured at each measurement point, and a single instance of measurement is sufficient.

If a database that contains information on the types of a variety of samples, their optical characteristics, and so on is prepared, by referring to the database, the sample 125 that is in contact with the first contact portion 121 can be predicted, and an image acquired by measuring the sample 125 at a plurality of points can be color-coded. Although the database is to be acquired in advance, as long a given method allows a complex refractive index to be obtained, reflectometry through a plate-like member or a transmission measurement of a single layer of a sample or a sample sandwiched by the objects 100 may be employed.

The sample 125 to be measured in the present exemplary embodiment includes any of a liquid, a solid, and a gas. A liquid is dropped on the first contact portion 121 in such a manner that an air bubble is not mixed into the liquid, and the liquid is prevented from transpiring with a lid or the like, if necessary. A solid is brought into tight contact with the first contact portion 121 in a method appropriate for a given sample, and the method includes thermobonding, the use of adhesive, and so on. A gas is sealed by a lid or the like so as to be prevented from diffusing.

In addition, the object 100 can be applied to a measurement in which biological tissue is used as the sample 125. Biological tissue serving as the sample 125, for example, is a section obtained by cutting out tissue from an organism and slicing the tissue into a thin film, a block obtained by fixing tissue that has been cut out from an organism with formalin or the like and then embedding the tissue into a paraffine block. Furthermore, when the shape of the object 100 according to the present exemplary embodiment is incorporated into the tip of a probe to be inserted into an organism, it becomes possible to measure a portion (a skin, a surface of an internal organ, etc.) of an organism of an animal or a human in a state in which the organism is alive (in-vivo).

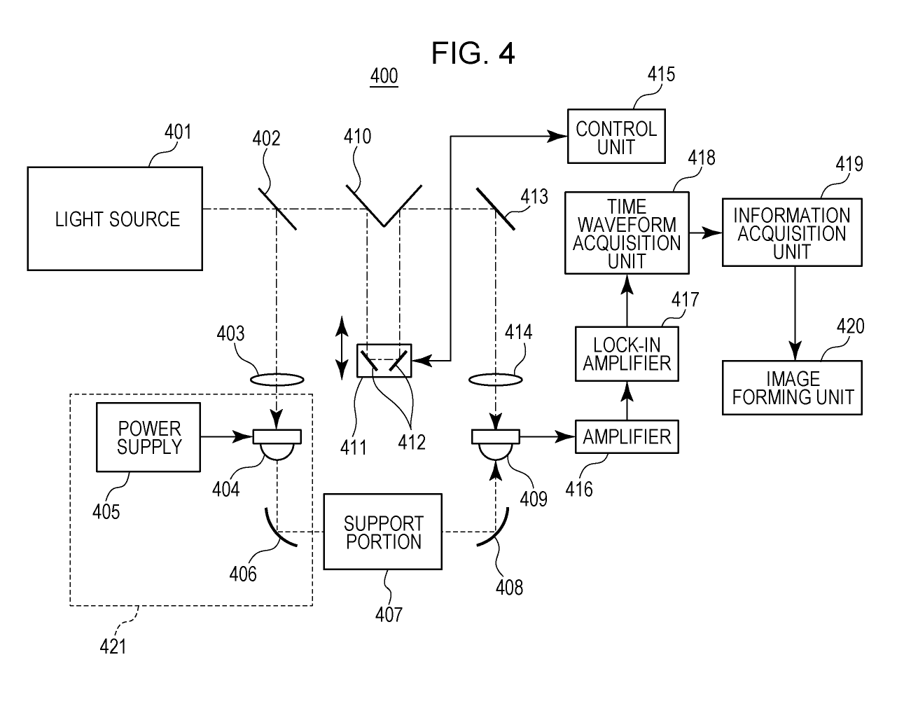

FIG. 4 illustrates the configuration of a reflective measurement apparatus 400 (hereinafter, referred to as the apparatus 400) that includes a support portion 407 for supporting the object 100 according to the present exemplary embodiment and that can measure a variety of samples including biological tissue. The apparatus 400 has a configuration that is similar to the configuration of a typical THz-TDS apparatus. The apparatus 400 includes a light source 401, an irradiation unit 421, the support portion 407, a detection unit 409, a mirror pair 410, a delay stage 411, a control unit 415, an amplifier 416, a lock-in amplifier 417, a time waveform acquisition unit 418, an information acquisition unit 419, and an image forming unit 420. The irradiation unit 421 includes a power supply 405, a generation unit 404, and a paraboloidal mirror 406.

A femtosecond laser beam with a pulse duration of approximately 100 femtosecond or less outputted by the light source 401 is split by a half-silvered mirror 402, and a part of the split femtosecond laser beam is converged by a lens 403 and reaches the generation unit 404. Upon the femtosecond laser beam being incident on the generation unit 404, a terahertz wave is generated. A photoconductive device is used for the generation unit 404. A bias voltage of the generation unit 404 is modulated by the power supply 405, and the terahertz wave modulated accordingly is guided to the support portion 407 by the paraboloidal mirror 406.

The support portion 407 supports the sample 125 and the plate-like member 100. In addition, as the support portion 407 is moved with the plate-like member 100 supported thereby, the support portion 407 also functions as a changing unit for changing a position where a terahertz wave is incident on the plate-like member 100, the sample 125 that is in contact with the plate-like member 100, and so on. As illustrated in FIG. 1, a terahertz wave reaches the sample 125 through the object 100. A terahertz wave reflected by the sample 125 is guided to a photoconductive device serving as the detection unit 409 for the terahertz wave by a paraboloidal mirror 408.

In the meantime, the remaining part of the split femtosecond laser beam is subjected to delay control by being reflected by the fixed mirror pair 410 and a mirror pair 412 mounted on the movable delay stage 411. The resulting laser beam is then converged by a mirror 413 and a lens 414 and reaches the detection unit 409. A control signal of the delay stage 411 is outputted by the control unit 415. Through such a configuration, the terahertz wave is detected by the detection unit 409.

A resulting signal corresponding to the terahertz wave detected by the detection unit 409 passes through the amplifier 416 and the lock-in amplifier 417 and is then detected, and the time waveform acquisition unit 418 acquires a time waveform from the stated signal. The information acquisition unit 419 carries out the processing described above by using the acquired time waveform and thus acquires information on the sample 125. The image forming unit 420 forms image data by using the acquired information on the sample 125. In a case in which a database is used, the image forming unit 420 makes a determination on a two-dimensional image on the basis of the database.

As described thus far, when a measurement is carried out with the object 100 according to the present exemplary embodiment, information on the plate-like member mixed in the time waveform measured by the reflective measurement apparatus can be reduced with ease. Consequently, the accuracy in the acquired information on the sample can be improved. Thus, even with a sample whose different conditions are hard to differentiate due to a slight information difference as in normal tissue and abnormal tissue of an organism, it is expected that highly accurate information can be obtained and the condition can be determined with high accuracy.

### Second Exemplary Embodiment

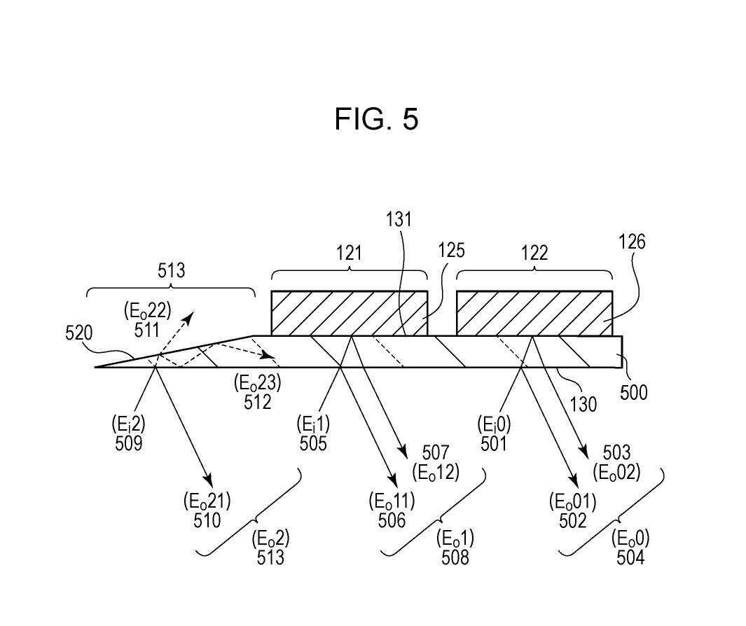

A plate-like member 500 (hereinafter, referred to as the object 500) according to a second exemplary embodiment will be described with reference to FIG. 5. FIG. 5 illustrates an overview of the object 500. The object 500 is preferably made of a material that highly transmits terahertz waves and whose physical properties are stable and known. As in the object 100 according to the first exemplary embodiment, the object 500 includes a first contact portion 121 and a second contact portion 122. In the first exemplary embodiment, the object 100 includes the thick separation portion 113 for temporally separating the second reflection pulse from the first reflection pulse. In the present exemplary embodiment, the object 500 includes a separation portion 513 for spatially separating the second reflection pulse from the first reflection pulse.

Hereinafter, a process of obtaining a complex refractive index, which serves as information on a sample 125, on the basis of a result obtained from reflectometry of a terahertz wave with the use of the object 500 will be described.

The first contact portion 121 and the second contact portion 122 are irradiated, respectively, with incident waves 505 (Eᵢ1) and 501 (Eᵢ0) on the front surface (first surface) 130 of the object 500, and reflection waves 508 (E₀1) and 504 (E₀0) that include pulses from the two interfaces are obtained accordingly. Time waveforms as illustrated in FIGS. 2A and 2B are acquired. A time waveform or data obtained by measuring the object 500 alone before the sample 125 is brought into tight contact with the first contact portion 121 may be substituted for the time waveform or data acquired by measuring the second contact portion 122.

The separation portion 513 has a sloped structure on a side that is opposite to the first surface 130 on which a terahertz wave is incident. This sloped structure includes a third surface 520 and spatially separates a second reflection pulse 512 from a first reflection pulse 510. The third surface 520 may be planar and sloped relative to the first surface 130 or may be curved. In the present exemplary embodiment, a case in which the third surface 520 is sloped relative to the first surface 130 will be described.

Of an incident wave 509 (Eᵢ2) incident on the first surface 130, a component transmitted through the first surface 130, except for a transmission wave 511 (E₀22) that is transmitted through an interface between the sloped structure of the object 500 and the air, is reflected by the third surface 520 and then travels toward an interface between the front surface of the object 500 and the air. At this point, if the angle of incidence of the reflection wave on the interface between the front surface of the object 500 and the air is no less than the total reflection angle, the reflection wave results in the reflection wave 512 (E₀22) that is totally reflected repeatedly within the object 500 until reaching an end of the object 500. Thus, a terahertz wave that propagates within the object 500 can be confined within the object 500. Consequently, only the reflection wave 510 (E₀21) from the front surface of the object 500 is observed in a reflection wave 513 (E₀2) obtained as the separation portion 513 is irradiated with the incident wave 509 (Eᵢ2), and a time waveform illustrated in FIG. 2C is acquired.

Procedures for calculating the complex refractive index of the sample 125 that is in tight contact with the first contact portion 121 from the three reflection waves E₀0, E₀1, and E₀2 acquired as above are the same as those in the first exemplary embodiment.

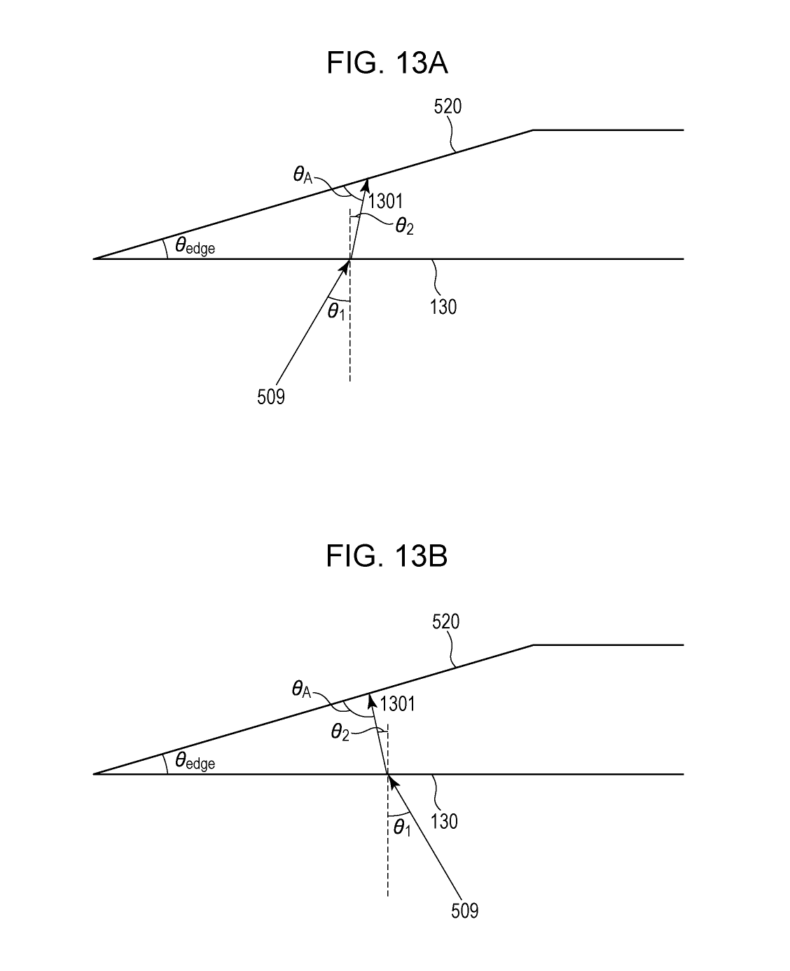

A relation between an angle of inclination of the third surface 520 and an angle of incidence θ₁ according to the present exemplary embodiment will be described. When a terahertz wave is made incident on the first surface 130 of the object 500, there are three possible directions of incidence. In one case, a terahertz wave is incident normally on the first surface 130, or in other words, the angle of incidence θ₁ is 0°. The remaining two cases will be described with reference to FIGS. 13A and 13B. With reference to FIGS. 13A and 13B, when the terahertz wave (incident wave) 509 is incident, at the angle of incidence θ₁, on the first surface 130 of the separation portion 513 in which the angle of inclination of the third surface 520 is θ_{edge}, an angle of refraction within the object 500 is θ₂. In addition, an angle formed by a propagation wave 1301 that propagates within the object 500 and the third surface 520 is represented by θ_{A}. The angle of refraction θ₂ corresponds to an angle formed by the direction in which the terahertz wave propagates after being incident on the first surface 130 and being refracted within the object 500 and a perpendicular to the first surface 130. FIG. 13A illustrates a case in which the angle θ_{A} is expressed by Expression (A). Meanwhile, FIG. 13B illustrates a case in which the angle θ_{A} is expressed by Expression (B). FIG. 5 illustrates a case in which the angle θ_{A} is expressed by Expression (A).

θ_{A}=90°−θ_{edge}−θ₂ (A)

θ_{A}=90°−θ_{edge}−θ₂ (B)

The angle of incidence (θ₁) of a terahertz wave as used in the present specification is defined as an angle formed by the optical axis of the incident wave 509 and the perpendicular to the first surface 130 of the object 500. In addition, the angle of inclination θ_{edge} of the third surface 520 is defined as an angle, within the object 500, formed by the first surface 130 and the third surface 520.

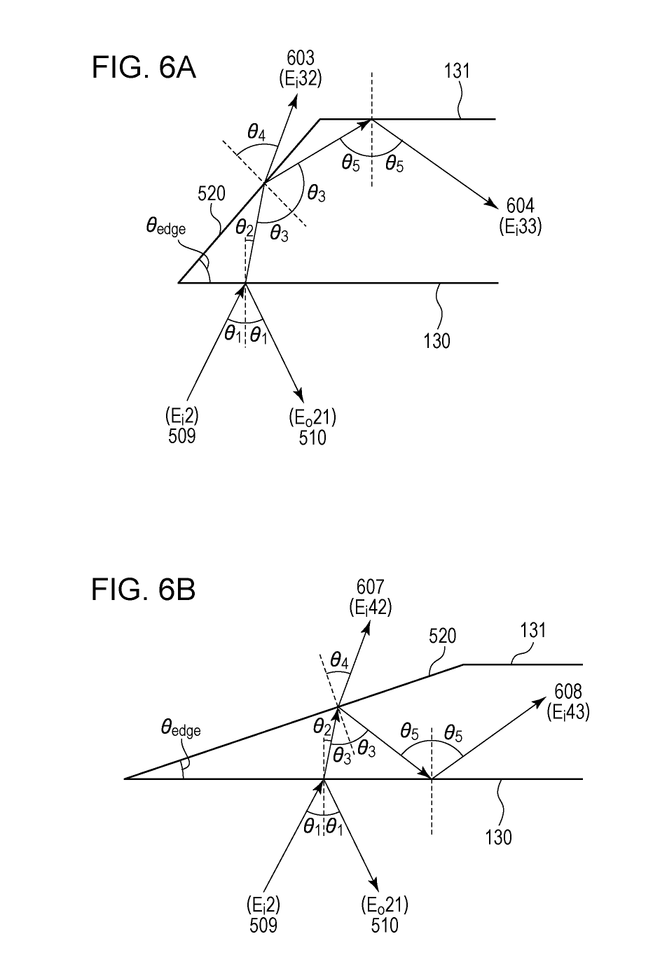

FIGS. 6A and 6B are each an enlarged view of the separation portion 513 and illustrate cases in which the angle θ_{A} is expressed by Expression (A). Depending on the relation between the angle of inclination θ_{edge} of the third surface 520 of the separation portion 513 and the angle of incidence θ₁ of the terahertz wave, a case 1 illustrated in FIG. 6A and a case 2 illustrated in FIG. 6B are feasible. In the case 1, the total reflection starts from the back surface (second surface) 131 of the object 500. In the case 2, the total reflection starts from the front surface (first surface) 130 of the object 500.

In the case 1, the incident wave 509 (Eᵢ2) incident on the first surface 130 is refracted thereby and propagates within the object 500. The resulting wave is then reflected by the third surface 520. At this point, a portion of the incident wave 509 (Eᵢ2) becomes a transmission wave 603 (Eᵢ32) that is transmitted through the third surface 520. The terahertz wave reflected by the third surface 520 is reflected by the second surface 131 and becomes a reflection wave 604 (Eᵢ33) that is totally reflected within the object 500. In the case 2, the incident wave 509 (Eᵢ2) incident on the first surface 130 is refracted thereby and propagates within the object 500. The resulting wave is then reflected by the third surface 520. At this point, a portion of the incident wave 509 (Eᵢ2) becomes a transmission wave 607 (Eᵢ42) that is transmitted through the third surface 520. The terahertz wave reflected by the third surface 520 is reflected by the first surface 130 and becomes a reflection wave 608 (Eᵢ43) that is totally reflected within the object 500.

The angle of incidence of the incident wave 509 (Eᵢ2) is represented by θ₁; the angle of refraction of the incident wave 509 within the object 500 is represented by θ₂; and the angle of incidence and the angle of refraction, at an interface between the third surface 520 and the air, of a terahertz wave that has been transmitted through the front surface of the object 500 and is incident on the third surface 520 are represented by θ₃ and θ₄, respectively. In the case 1, the angle of incidence, at an interface between the second surface 131 and the air, of a terahertz wave that has been reflected by the third surface 520 and is incident on the second surface 131 is represented by θ₅. Meanwhile, in the case 2, the angle of incidence, at an interface between the first surface 130 and the air, of a terahertz wave that has been reflected by the third surface 520 and is incident on the first surface 130 is represented by θ₅. The incident wave 509 propagates in a manner illustrated in the case 1 when the angle of inclination θ_{edge} and the angle of incidence θ₃ are in the relation expressed by Expression (5) and propagates in a manner illustrated in the case 2 when the stated angles θ_{edge} and θ₃ are in the relation expressed by Expression (6). When both sides in Expression (5) and in Expression (6) are equal to each other, a reflection wave reflected by the interface between the third surface 520 and the air travels in a direction parallel to the back surface of the object 500.

θ₃>90°−θ_{edge} (5)

θ₃<90°−θ_{edge} (6)

In order to confine the terahertz wave within the object 500, in either the case 1 or the case 2, the angle of incidence θ₅ may be no less than the total reflection angle. In each of the case 1 and the case 2, a relation among the angle of inclination θ_{edge}, the angle of incidence θ₅, and the angle of incidence θ₃ is expressed by Expression (7) and Expression (8).

θ₅=180°−θ_{edge}−θ₃ (7)

θ₅=θ_{edge}+θ₃ (8)

In addition, in either the case 1 or 2, a relation between the angle of incidence θ₃ and the angle of refraction δ₂ and a relation between the angle of refraction δ₂ and the angle of incidence θ₁ are expressed, respectively, by Expression (9) and Expression (10), and the condition for total reflection is expressed by Expression (11). Here, the refractive index of the air is 1, and the refractive index of the object 500 is n_{W}.

$$\begin{matrix}{θ}_{3} = {θ}_{edge} + {θ}_{2} & ( 9 ) \\ {θ}_{2} = {sin}^{- 1} ( \frac{sin {θ}_{1}}{{n}_{W}} ) & ( 10 ) \\ {θ}_{5} \geq {sin}^{- 1} ( \frac{1}{{n}_{W}} ) & ( 11 )\end{matrix}$$

On the basis of the above, when the condition for total reflection is expressed only by the angle of inclination θ_{edge} and the angle of incidence θ₁, the case 1 is expressed by Expression (12), and the case 2 is expressed by Expression (13).

$$\begin{matrix}180 ° - 2 {θ}_{edge} \geq {sin}^{- 1} ( \frac{1}{{n}_{W}} ) + {sin}^{- 1} ( \frac{sin {θ}_{1}}{{n}_{W}} ) & ( 12 ) \\ 2 {θ}_{edge} \geq {sin}^{- 1} ( \frac{1}{{n}_{W}} ) - {sin}^{- 1} ( \frac{sin {θ}_{1}}{{n}_{W}} ) & ( 13 )\end{matrix}$$

When the two cases are combined, in the present exemplary embodiment, it is desirable that the angle of incidence θ₁ of the terahertz wave and the angle of inclination θ_{edge} of the third surface 520 satisfy the condition of Expression (14).

$$180 ° - {sin}^{- 1} ( \frac{1}{{n}_{W}} ) - {sin}^{- 1} ( \frac{sin {θ}_{1}}{{n}_{W}} ) \geq 2 {θ}_{edge} \geq {sin}^{- 1} ( \frac{1}{{n}_{W}} ) - {sin}^{- 1} ( \frac{sin {θ}_{1}}{{n}_{W}} ) \qquad ( 14 )$$

When 15 degrees is substituted for the angle of incidence and 2.11 of z-cut quartz is substituted for the refractive index n_{W}, the angle of incidence θ_{edge} may be within a range expressed by Expression (15).

72.3°≧θ_{edge}≧10.6° (15)

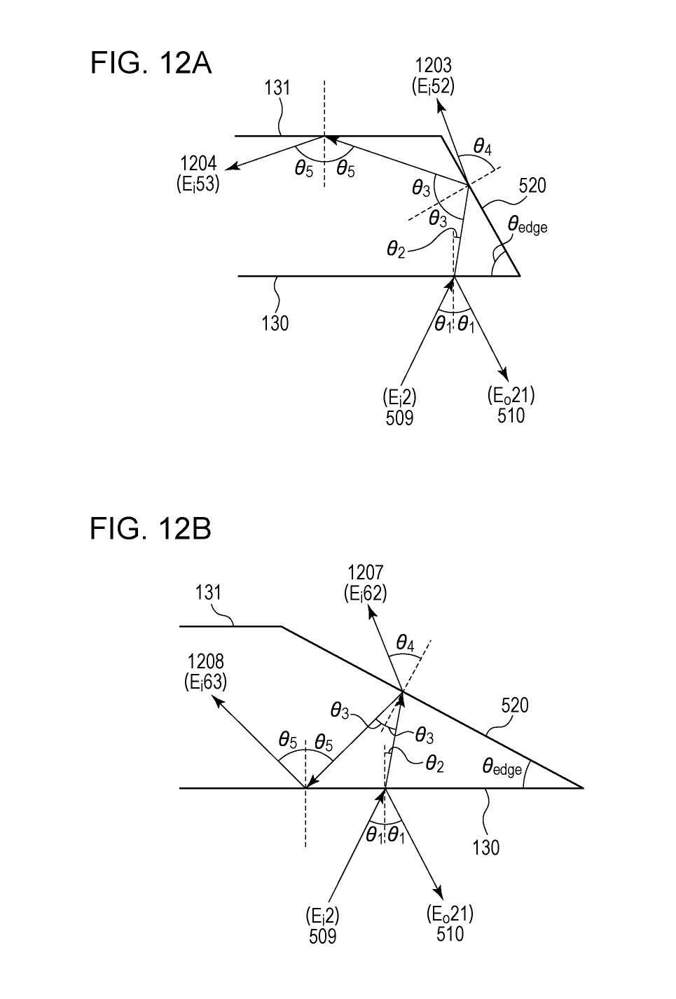

Thus far, cases in which the angle θ_{A} formed by the propagation wave 1301 within the object 500 and the third surface 520 is expressed by Expression (A) have been described. Hereinafter, cases in which the angle θ_{A} formed by the propagation wave 1301 within the object 500 and the third surface 520 is expressed by Expression (B) will be described with reference to FIGS. 12A and 12B. These cases correspond to a case in which the direction in which the terahertz wave is incident is fixed and the orientation of the object 500 is reversed horizontally in FIG. 5 or a case in which the disposition of the object 500 is fixed and the direction in which the terahertz wave is incident is reversed.

When the angle θ_{A} formed by the propagation wave 1301 within the object 500 and the third surface 520 is expressed by Expression (B) as well, two cases are feasible depending on the difference in a surface from which the total reflection starts. Hereinafter, the two cases are referred to as a case 3 and a case 4. As illustrated in FIG. 12A, in the case 3, the total reflection starts from the back surface (second surface) 131 of the object 500. Meanwhile, as illustrated in FIG. 12B, in the case 4, the total reflection starts from the front surface (first surface) 130 of the object 500.

In the case 3, the incident wave 509 (Eᵢ2) incident on the first surface 130 is refracted thereby and propagates within the object 500. The resulting wave is then reflected by the third surface 520. At this point, a portion of the incident wave 509 (Eᵢ2) becomes a transmission wave 1203 (Eᵢ52) that is transmitted through the third surface 520. The terahertz wave reflected by the third surface 520 is reflected by the second surface 131 and becomes a reflection wave 1204 (Eᵢ53) that is totally reflected within the object 500. In the case 4, the incident wave 509 (Eᵢ2) incident on the first surface 130 is refracted thereby and propagates within the object 500. The resulting wave is then reflected by the third surface 520. At this point, a portion of the incident wave 509 (Eᵢ2) becomes a transmission wave 1207 (Eᵢ62) that is transmitted through the third surface 520. The terahertz wave reflected by the third surface 520 is reflected by the first surface 130 and becomes a reflection wave 1208 (Eᵢ63) that is totally reflected within the object 500.

As in the cases 1 and 2 described above, a case in which θ_{edge} and θ₃ are in the relation expressed by Expression (5) corresponds to the case 3, and a case in which θ_{edge} and θ₃ are in the relation expressed by Expression (6) corresponds to the case 4. When both sides in Expression 5 and in Expression 6 are equal to each other, a reflection wave from the interface between the third surface 520 and the air travels in the direction parallel to the second surface 131 and is not reflected until the reflection wave travels back and forth in the object 500. When the angle θ_{A} formed by the propagation wave 1301 within the object 500 and the third surface 520 is expressed by Expression (B) as well, the condition for total reflection can be obtained through procedures similar to the procedures described above. When the conditions for total reflection in the cases 3 and 4 are expressed only by θ_{edge} and θ₁, the conditions are expressed by Expression (16) and Expression (17).

$$\begin{matrix}180 ° - 2 {θ}_{edge} \geq {sin}^{- 1} ( \frac{1}{{n}_{W}} ) - {sin}^{- 1} ( \frac{sin {θ}_{1}}{{n}_{W}} ) & ( 16 ) \\ 2 {θ}_{edge} \geq {sin}^{- 1} ( \frac{1}{{n}_{W}} ) + {sin}^{- 1} ( \frac{sin {θ}_{1}}{{n}_{W}} ) & ( 17 )\end{matrix}$$

When the cases 3 and 4 are combined, in a case in which the angle θ_{A} formed by the propagation wave 1301 within the object 500 and the third surface 520 is expressed by Expression (B), it is desirable that the angle of incidence θ₁ of the terahertz wave and the angle of inclination θ_{edge} of the sloped structure satisfy the condition of Expression (18).

$$180 ° - {sin}^{- 1} ( \frac{1}{{n}_{W}} ) + {sin}^{- 1} ( \frac{sin {θ}_{1}}{{n}_{W}} ) \geq 2 {θ}_{edge} \geq {sin}^{- 1} ( \frac{1}{{n}_{W}} ) + {sin}^{- 1} ( \frac{sin {θ}_{1}}{{n}_{W}} ) \qquad ( 18 )$$

When 15 degrees is substituted for the angle of incidence and 2.11 of z-cut quartz is substituted for the refractive index n_{W}, the angle of incidence θ_{edge} may be within a range expressed by Expression (19).

79.4°≧θ_{edge}≧17.7° (19)

In addition, in a similar manner, with respect to a case in which a terahertz wave is incident normally on the first surface 130 of the object 500, two cases are feasible depending on the difference in a surface from which total reflection starts. Hereinafter, a case in which total reflection starts from the back surface (second surface) 131 of the object 500 is referred to as a case 5, and a case in which total reflection starts from the front surface (first surface) 130 of the object 500 is referred to as a case 6. When the terahertz wave is incident normally, a case in which the angle of inclination θ_{edge} is greater than 45° corresponds to the case 5, and a case in which the angle of inclination θ_{edge} is less than 45° corresponds to the case 6. When the angle of inclination θ_{edge} is equal to 45°, a reflection wave from the interface between the third surface 520 and the air travels in the direction parallel to the second surface 131 and is not reflected until the reflection wave travels back and forth in the object 500. When the cases 5 and 6 are combined, in a case in which the terahertz wave is incident normally on the first surface 130, it is desirable that the angle of inclination θ_{edge} satisfy Expression (C).

$$180 ° - {sin}^{- 1} ( \frac{1}{{n}_{W}} ) \geq 2 {θ}_{edge} \geq {sin}^{- 1} ( \frac{1}{{n}_{W}} ) \qquad ( C )$$

As described thus far, when a measurement is carried out with the object 500 according to the present exemplary embodiment, information on the plate-like member mixed in the time waveform measured by the reflective measurement apparatus can be reduced with ease. Consequently, the accuracy in the acquired information on the sample can be improved. Thus, even with a sample whose different conditions are hard to differentiate due to a slight difference in the optical characteristics as in normal tissue and abnormal tissue of an organism, it is expected that highly accurate information can be obtained and the condition can be determined with high accuracy.

In addition, the object 500 can be obtained merely by obliquely scraping a tip of a plate-like member when the object 500 is fabricated, and thus the object 500 can be fabricated with ease and at reduced cost as compared to a case in which the object 100 according to the first exemplary embodiment is fabricated. Depending on the thickness of the object 500 or the beam diameter of the terahertz wave, the separation portion 113 of the object 100 may need to be provided with a third surface in order to confine the terahertz wave within the object 100, and the present exemplary embodiment can be applied in such a case as well.

### Third Exemplary Embodiment

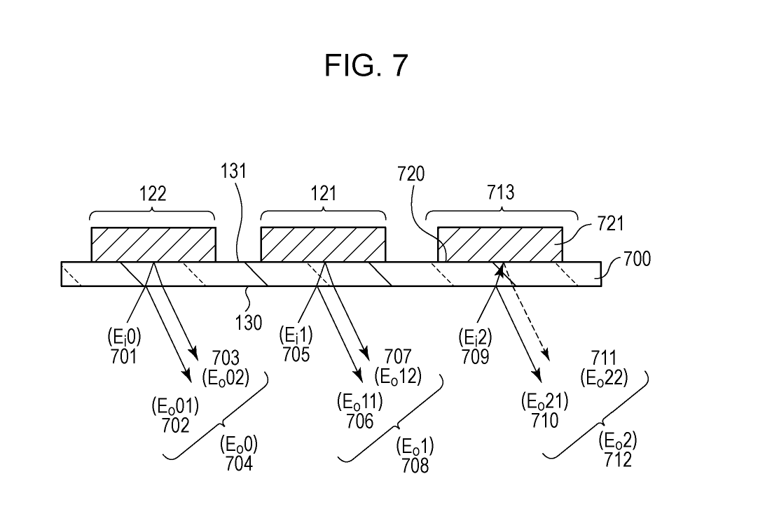

A plate-like member 700 (hereinafter, referred to as the object 700) according to the present exemplary embodiment will be described with reference to FIG. 7. FIG. 7 illustrates an overview of the object 700. As in the first and second exemplary embodiments, the object 700 includes a first contact portion 121 and a second contact portion 122. The plate-like members according to the first and second exemplary embodiments are provided with the separation portions 113 and 513, respectively, and the second reflection pulse is temporally or spatially separated from the first reflection pulse. In the present exemplary embodiment, the object 700 includes a separation portion 713 for obtaining only the first reflection pulse reflected by the front surface of the object 700. The separation portion 713 is a region that lies along the same plane as the first contact portion 121 and the second contact portion 122 and that is coated with an absorbing material 721 that absorbs a terahertz wave so as to prevent the second reflection pulse from being generated.

A process of calculating a complex refractive index, which serves as the information on the sample 125, on the basis of a measurement result obtained from reflectometry of a terahertz wave with the use of the object 700 will be described. As in the first and second exemplary embodiments, the first contact portion 121 and the second contact portion 122 are irradiated, respectively, with incident waves 705 (Eᵢ1) and 701 (Eᵢ0) on the front surface of the object 700, and reflection waves 708 (E₀1) and 704 (E₀0) that include reflection waves from the two interfaces are obtained accordingly. Time waveforms as illustrated in FIGS. 2A and 2B are acquired. A time waveform acquired by measuring the object 700 alone before the sample 125 is brought into tight contact with the first contact portion 121 or data acquired from the stated time waveform may be substituted for the time waveform acquired by measuring the second contact portion 122 or data acquired from the stated time waveform.

The structure of the separation portion 713 is such that a surface opposite to the front surface of the object 700 on which an incident wave is incident, or in other words, the back surface of the object 700 is coated with the absorbing material 721. The absorbing material 721 is a material that absorbs a terahertz wave in a frequency band of an incident wave 709, and a thin film or the like of, for example, carbon nanotube or metal nanotube, which is being developed as a terahertz detection material that operates at room temperature, can be used. Of the incident wave 709 (Eᵢ2) reaching the separation portion 713, a reflection wave 711 (E₀22) from an interface between the object 700 and the absorbing material 721 has an intensity that is expressed by Expression (20). The intensity of the incident wave 709 is represented by Eᵢ2; the complex amplitude transmittance from the air to the object 700 is represented by t_{aw}; the complex amplitude reflectance at the interface between the object 700 and the absorbing material 721 is represented by r_{wb}; and the complex amplitude transmittance from the object 700 to the air is represented by t_{ws}.

E_{O22}≦Eᵢ₂·t_{aw}·r_{wb}·t_{wa} (20)

When the object 700 is made of a material that is highly transmissive and is not absorptive, an influence of absorption by the absorbing material 721 is included in r_{wb}, and the amplitude intensity of the reflection wave 711 is affected by the stated component. Therefore, when the absorbing material 721 is made of a material that highly absorbs a terahertz wave to an extent that the reflection wave 711 has a noise level that is no higher than the noise level of the reflection wave 710 (E₀21), the reflection wave 711 is not observed in a time waveform of a reflection wave 712 (E₀2). Consequently, only the reflection wave 710 reflected by the front surface of the object 700 appears in the reflection wave 712, and a time waveform as illustrated in FIG. 2C is acquired.

Procedures for calculating the complex refractive index of the sample 125 that is in tight contact with the first contact portion 121 from the three reflection waves acquired as above are the same as those in the first exemplary embodiment.

In addition, the back surface of the separation portion 713 of the object 700 may be coated with an anti-reflection film for a terahertz wave in addition to the absorbing material 721. Although an anti-reflection film utilizes interference of light instead of absorption, a similar effect can be obtained in that an occurrence of the second reflection pulse is suppressed, and a time waveform such as the one illustrated in FIG. 2C is acquired, as in a case in which the absorbing material 721 is applied.

When a measurement is carried out with the object 700 according to the present exemplary embodiment, information on the plate-like member mixed in the time waveform measured by the reflective measurement apparatus can be reduced with ease. Consequently, the accuracy in the acquired information on the sample can be improved. Thus, even with a sample whose different conditions are hard to differentiate due to a slight difference in the optical characteristics as in normal tissue and abnormal tissue of an organism, it is expected that highly accurate information can be obtained and the condition can be determined with high accuracy.

### First Implementation Example

As a first implementation example, a method for acquiring information on the sample 125 by using the object 100 according to the first exemplary embodiment will be described in more concrete terms. In the present implementation example, a z-cut quartz plate is used as the object 100; pure water (resistivity of approximately 18 MΩ·cm and organic matter content of 3 ppb) is used as the sample 125; and the air is used as the control sample 126. The quartz plate has a thickness of approximately 1 mm at each of the first contact portion 121 and the second contact portion 122 and a thickness of approximately 6 mm at the separation portion 113.

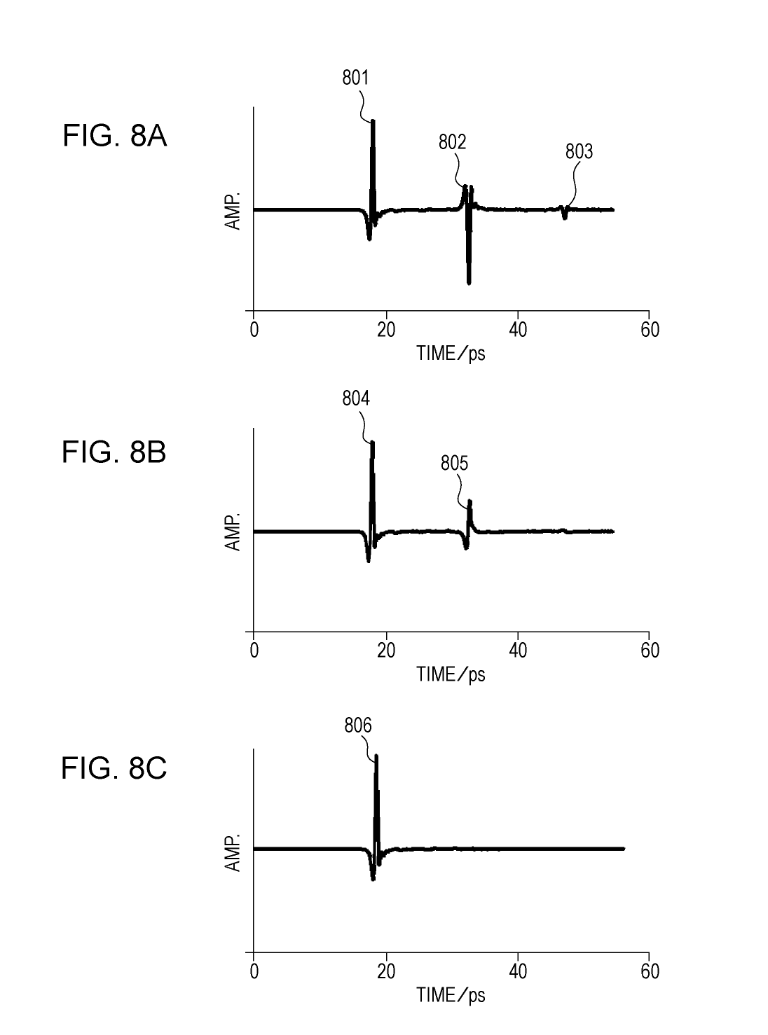

FIG. 8A illustrates a time waveform of the reflection wave 104 in the second contact portion 122 acquired through a measurement with the apparatus 400, which is a reflective THz-TDS apparatus. In addition, FIG. 8B illustrates a time waveform of the reflection wave 108 in the first contact portion 121 measured by the apparatus 400, and FIG. 8C illustrates a time waveform of the reflection wave 112 in the separation portion 113 measured by the apparatus 400. The incident waves are made incident on the front surface of the object 100, or in other words, the surface that is opposite to the surface in contact with the sample 125.

In the time waveform in the second contact portion 122 illustrated in FIG. 8A, three reflection waves 801-803 are observed. The reflection waves 801 and 802 are reflection waves, respectively, from an interface between the air and the quartz and from an interface between the quartz and the air; and the reflection wave 803 is a reflection wave reflected three times within the object 100. In the time waveform in the first contact portion 121 illustrated in FIG. 8B, primarily two reflection waves 804 and 805 are observed. The reflection waves 804 and 805 are reflection waves, respectively, from an interface between the air and the quartz and from an interface between the quartz and the pure water. Although a third reflection wave caused by multiple reflection within the object 100 is also present as in the second contact portion 122, this reflection wave is at a level that cannot be observed in the time waveform. This is because the stated reflection wave is absorbed by the pure water as the difference in the refractive index between the quartz plate and the pure water (Δn˜0.01 at 1 THz) is small as compared to the difference in the refractive index between the quartz plate and the air (Δn˜1.1 at 1 THz). In the time waveform in the separation portion 113 illustrated in FIG. 8C, only a reflection wave 806 from an interface between the quartz and the air is observed.

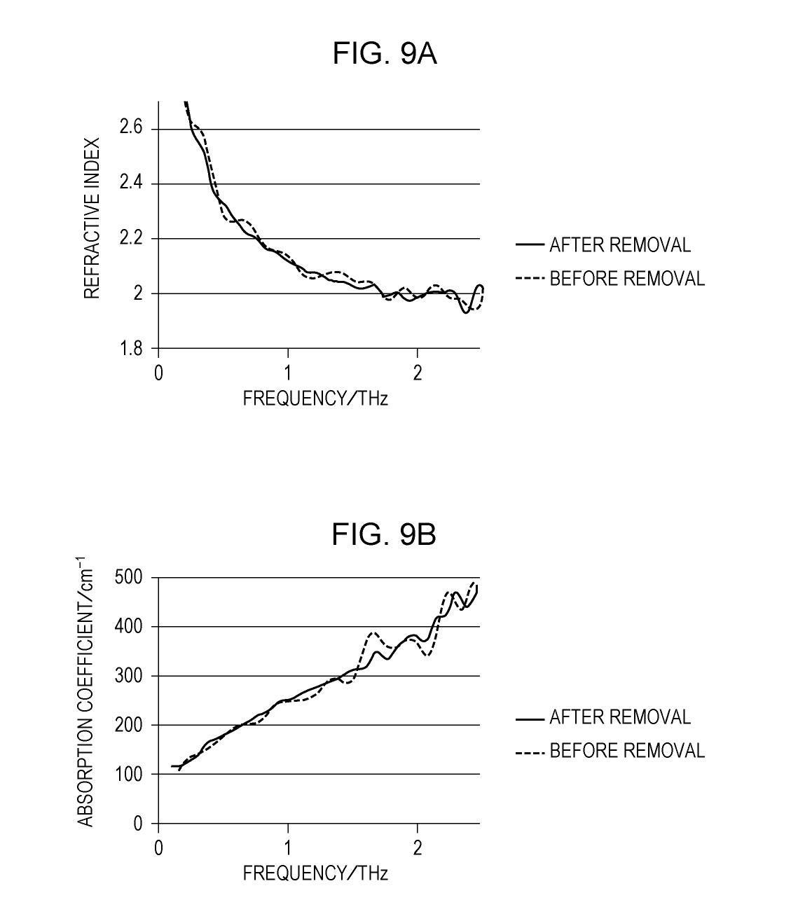

In the present implementation example, a time waveform in which residual components corresponding to the interface between the air and the quartz are subtracted from the reflection wave 802 and the reflection wave 805 is acquired by using the time waveform acquired in the separation portion 113, in accordance with the procedures described in the first exemplary embodiment. With the use of the acquired time waveform, a refractive index spectrum and an absorption coefficient spectrum are acquired as the information on the sample 125. FIG. 9A illustrates the refractive index spectrum, and FIG. 9B illustrates the absorption coefficient spectrum. For comparison, for each of the spectra, a spectrum in which the residual component is removed is indicated by a solid line, and a spectrum in which the residual component is not removed is indicated by a dotted line.

In either of FIG. 9A and FIG. 9B, an oscillation component that is periodical relative to the frequency appears in the spectrum in which the residual component is not removed, and it is speculated that the spectrum does not represent an accurate spectral shape. With regard to the spectra of water in a terahertz wave range reported in the past, the refractive index spectrum decreases as the frequency increases, and the absorption coefficient spectrum increases as the frequency increases. Thus, a distinctive peak is not observed in either spectrum. With regard to the spectrum in which the residual component is removed, the vibrational component is suppressed, and it is speculated that the spectrum more accurately represents the spectral shape of water. In other words, according to the first exemplary embodiment, information on the plate-like member can be reduced with ease from a time waveform measured by the reflective measurement apparatus, and the information on the sample 125 in contact with the object 100 can be acquired with higher accuracy as a result.

On the basis of the comparison of these spectra, it is understood that a primary cause for the vibrational components appearing in the spectra is residual components of the reflection waves from the interface between the air and the object 100 that are included in the reflection wave from the interface between the object 100 and the air in the second contact portion 122 and in the reflection wave from the interface between the object 100 and the pure water in the first contact portion 121. The residual components contains an attenuated component of the reflection waves at a variety of wavelengths that have been reflected by the interface between the air and the object 100, and although the residual components attenuate with time, the residual components are continuously present.

In accordance with the procedures illustrated in FIG. 3, the reflection waves from the respective interfaces are separated from the time waveforms acquired in the first contact portion 121 and the second contact portion 122. In this case, the first reflection pulse from the interface between the air and the object 100 is cut out immediately before the second reflection pulse from the interface between the object 100 and the pure water or from the interface between the object 100 and the air. The time interval for separating the second reflection pulse is set to the same time interval for separating the first reflection pulse so that the number of data points in Fourier transform signals matches. Therefore, it is preferable that the separation portion 113 of the object 100 have a thickness that is no less than twice the time interval for separating the first reflection pulse, and it is more preferable that the stated thickness be no less than three times the time interval. In other words, although the distance between the front surface of the object 100 and the back surface of the object 100, or the thickness of the object 100 at the separation portion 113 is set to 6 mm in the present implementation example, since the thickness of the object 100 at the first contact portion 121 and the second contact portion 122 is approximately 1 mm, an actual thickness of approximately 2-3 mm is sufficient.

In addition, it is considered that the spectrum in a terahertz wave range is identical for any pure water having identical values of resistivity, organic matter content, and so on. Therefore, the configuration can be such that the spectrum of pure water having identical values of resistivity, organic matter content, and so on is acquired with high accuracy by using the object 100 and the acquired spectrum is used as a reference spectrum. A spectrum of a sample obtained from a time waveform acquired by using the apparatus 400 may vary between measurements even when the measurements are carried out with the same apparatus 400. This is because the conditions of the light source 401, the generation unit 404, the detection unit 409, and the optical systems, such as mirrors, present in an optical path of a laser beam or a propagation path of a terahertz wave are affected by a change in the surrounding environment such as the temperature and the humidity. In addition, an influence of an adjusting technique of a technician who adjusts the apparatus 400 may also be considered.

Therefore, as a spectrum of pure water is acquired before a measurement starts or each time a measurement is carried out and the acquired spectrum of pure water is compared with the reference spectrum so as to remove an influence of a variation, the accuracy in the measurement with the apparatus 400 can be improved.

As described thus far, when a measurement is carried out with the object 100 according to the present implementation example, information on the plate-like member mixed in the time waveform measured by the reflective measurement apparatus can be reduced with ease. Consequently, the accuracy in the acquired information on the sample can be improved.

### Second Implementation Example

As a second implementation example, an example in which information on the sample 125 is acquired by using the object 100 according to the first exemplary embodiment will be described in more concrete terms. In the present implementation example, a z-cut quartz plate is used as the object 100; a biological tissue section of a rat is used as the sample 125; and the air is used as the control sample 126. The quartz plate has a thickness of 1 mm at each of the first contact portion 121 and the second contact portion 122 and a thickness of 6 mm at the separation portion 113.

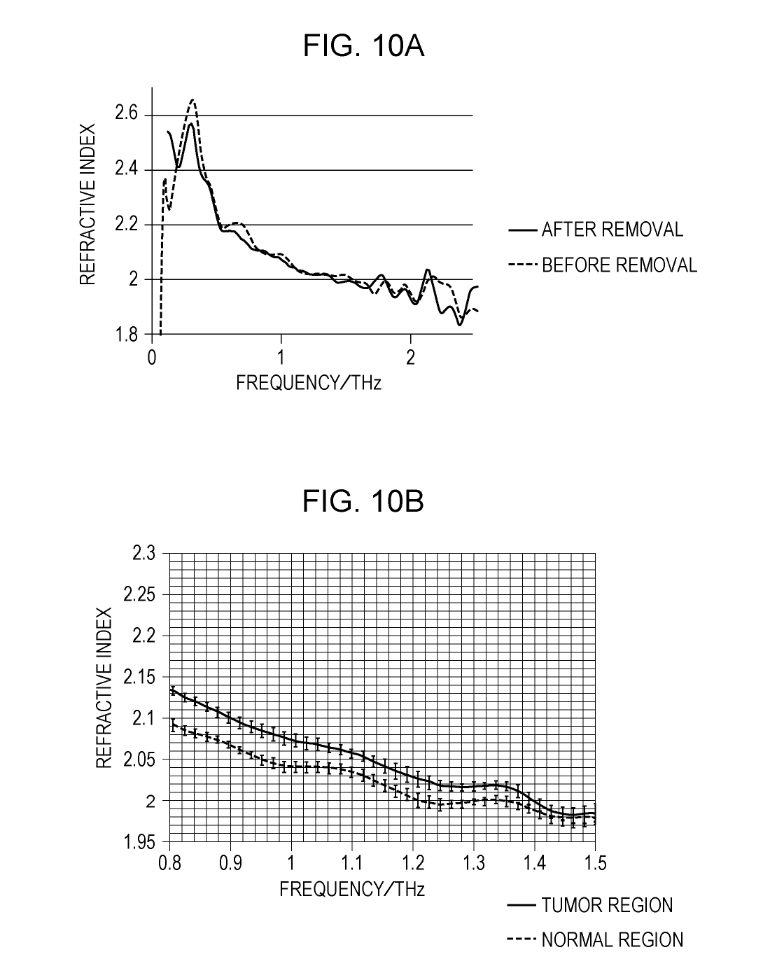

In accordance with the procedures described in the first exemplary embodiment, a refractive index spectrum is acquired as the information on the sample 125. FIG. 10A illustrates the refractive index spectrum acquired by using a section of a normal rat brain as the sample 125.

As in the first implementation example, it is understood that a vibrational component present when a residual component is not removed is suppressed when the residual component is removed. Biological tissue of animals contains a large amount of water, and thus it is considered that the value and the shape of a refractive index spectrum and an absorption coefficient spectrum to be acquired are close to those of water. Actually, a spectrum of biological tissue of animals in a terahertz range resembles that of pure water, and it is reported that a distinctive peak is not observed. It is considered that a drop in the refractive index spectrum at a low frequency side is due to the shape of the sample 125. The beam diameter of an incident wave in the apparatus 400 is 3 mm or more at 0.5 THz or less and increases more steeply as the frequency is lower. A region in which the frequency is low and the beam diameter is large includes an atmospheric region in which a rat biological tissue section is not present, and thus the influence thereof is reflected on the shape of the spectrum.

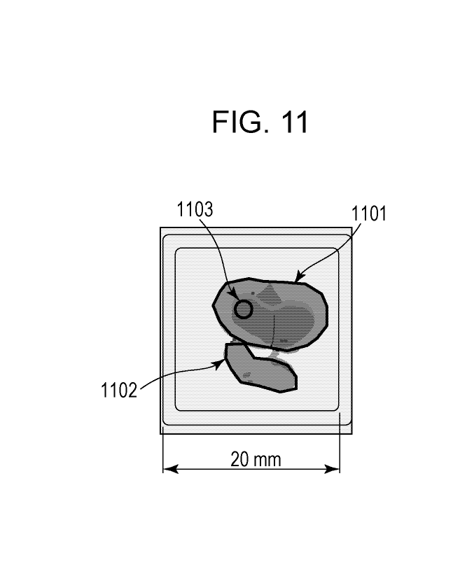

Furthermore, FIG. 10B illustrates refractive index spectra acquired by measuring a normal region 1101 and a tumor region 1102 within a section of a rat brain having brain tumor. FIG. 11 represents an actual photograph of a section of the rat brain having brain tumor. Measurements are taken at five points within a region 1103 enclosed by a circle in the normal region 1101 and at five points within the tumor region 1102. FIG. 10B illustrates the refractive index spectra obtained from the measurement results. The refractive index spectrum is a mean value of the measurement results, and an error bar indicates the standard deviation.

A significant refractive index difference Δn of approximately 0.02 or more and 0.04 or less is observed in a frequency band from 0.8 THz to 1.3 THz inclusive between the refractive index spectrum in the normal region 1101 and the refractive index spectrum in the tumor region 1102. On the basis of the above, it is understood that the refractive index is higher in the tumor region 1102 than in the normal region 1101. A difference in water content or a difference in cell density between the tumor region 1102 and the normal region 1101 is considered to be a primary cause for the refractive index difference. Including an effect of improving the accuracy in the acquired information by removing the pulse residual component, with the apparatus 400 used for the measurement and under the sample preparation condition described above, the refractive index difference of 0.02 can be observed in a frequency band from 0.8 THz to 1.5 THz inclusive.

When a process of removing the pulse residual component is not carried out, the spectral shapes of the tumor region 1102 and the normal region 1101 change independently. Therefore, the accuracy in observing these slight refractive index differences decreases. On the basis of the above, with the use of the object 100, the information on the object 100 in the acquired time waveform can be reduced with ease, and the accuracy in the acquired information on the sample 125 can be improved as a result. In other words, with regard to the sample 125 that is in contact with the object 100, a spectrum can be measured with higher accuracy, and a differentiation between conditions with a slight difference in optical characteristics can be made.

As described thus far, when a measurement is carried out with the object 100 according to the present implementation example, information on the plate-like member mixed in the time waveform measured by the reflective measurement apparatus can be reduced with ease. Consequently, the accuracy in the acquired information on the sample can be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-176289, filed Aug. 29, 2014, which is hereby incorporated by reference herein in its entirety.

What is claimed is:

1. A plate-like member to be used in a measurement apparatus configured to measure a time waveform of a terahertz wave, the plate-like member comprising:
a sample contact portion including a first surface and a second surface that is opposite to the first surface, the first surface being configured to receive a terahertz wave, the second surface being configured to come into contact with a sample when a measurement is carried out; and
a separation portion including the first surface and a third surface that is opposite to the first surface,
wherein the separation portion is configured such that a time waveform acquired as the measurement apparatus irradiates the separation portion with a terahertz wave includes only a time waveform of a terahertz wave reflected by the first surface or such that a time difference between a time at which a terahertz wave reflected by the first surface is detected and a time at which a terahertz wave reflected by the third surface is detected is greater than a time difference between the time at which the terahertz wave reflected by the first surface is detected and a time at which a terahertz wave reflected by the second surface is detected.

2. The plate-like member according to claim 1,
wherein a distance between the first surface and the third surface is greater than a distance between the first surface and the second surface.

3. The plate-like member according to claim 2,
wherein the distance between the first surface and the third surface is no less than twice the distance between the first surface and the second surface.

4. The plate-like member according to claim 1,
wherein the third surface is inclined relative to the first surface.

5. The plate-like member according to claim 4,
wherein an angle θ_{edge} formed by the first surface and the third surface satisfies:
$${θ}_{A} = 90 ° - {θ}_{edge} - {θ}_{2} , \\ and$$
$$180 ° - {sin}^{- 1} ( \frac{1}{{n}_{W}} ) - {sin}^{- 1} ( \frac{sin {θ}_{1}}{{n}_{W}} ) \geq 2 {θ}_{edge} \geq {sin}^{- 1} ( \frac{1}{{n}_{W}} ) - {sin}^{- 1} ( \frac{sin {θ}_{1}}{{n}_{W}} ) , \qquad$$
wherein θ₁ represents an angle of incidence of a terahertz wave incident on the first surface, θ₂ represents an angle formed by a perpendicular to the first surface and a propagation direction of a terahertz wave that has passed through the first surface, θ_{A} represents an angle formed by the third surface and a terahertz wave incident on the third surface, and n_{W} represents a refractive index.

6. The plate-like member according to claim 4,
wherein an angle θ_{edge} formed by the first surface and the third surface satisfies:
$${θ}_{A} = 90 ° - {θ}_{edge} + {θ}_{2} , \\ and$$
$$180 ° - {sin}^{- 1} ( \frac{1}{{n}_{W}} ) - {sin}^{- 1} ( \frac{sin {θ}_{1}}{{n}_{W}} ) \geq 2 {θ}_{edge} \geq {sin}^{- 1} ( \frac{1}{{n}_{W}} ) - {sin}^{- 1} ( \frac{sin {θ}_{1}}{{n}_{W}} ) , \qquad$$
wherein θ₁ represents an angle of incidence of a terahertz wave incident on the first surface, θ₂ represents an angle formed by a perpendicular to the first surface and a propagation direction of a terahertz wave that has passed through the first surface, θ_{A} represents an angle formed by the third surface and a terahertz wave incident on the third surface, and n_{W} represents a refractive index.

7. The plate-like member according to claim 4,
wherein an angle θ_{edge} formed by the first surface and the third surface satisfies:
$$180 ° - {sin}^{- 1} ( \frac{1}{{n}_{W}} ) \geq 2 {θ}_{edge} \geq {sin}^{- 1} ( \frac{1}{{n}_{W}} ) , \\ and$$
$$180 ° - {sin}^{- 1} ( \frac{1}{{n}_{W}} ) - {sin}^{- 1} ( \frac{sin {θ}_{1}}{{n}_{W}} ) \geq 2 {θ}_{edge} \geq {sin}^{- 1} ( \frac{1}{{n}_{W}} ) - {sin}^{- 1} ( \frac{sin {θ}_{1}}{{n}_{W}} ) ,$$
when an angle of incidence θ₁ of a terahertz wave incident on the first surface is 0°, and
wherein n_{W} represents a refractive index.

8. The plate-like member according to claim 1,
wherein at least one of an absorbing material that absorbs the terahertz wave and an anti-reflection film is disposed on the third surface.

9. The plate-like member according to claim 1,
wherein the distance between the first surface and the second surface is, in an optical length, from 0.5 mm to 3 mm inclusive.

10. The plate-like member according to claim 1, further comprising:
a control sample contact portion including the first surface and the second surface, the control sample contact portion being configured to come into contact with a control sample at the second surface when a measurement is carried out by the measurement apparatus.

11. A measurement apparatus configured to measure a time waveform of a terahertz wave, the measurement apparatus comprising:
an irradiation unit configured to irradiate a sample with a terahertz wave through a plate-like member;
a detection unit configured to detect a terahertz wave reflected by the sample; and
an acquisition unit configured to acquire a time waveform of a terahertz wave on the basis of a result of detection by the detection unit, wherein
the plate-like member comprises:
a sample contact portion including a first surface and a second surface that is opposite to the first surface, the first surface being configured to receive a terahertz wave, the second surface being configured to come into contact with a sample when a measurement is carried out; and
a separation portion including the first surface and a third surface that is opposite to the first surface,
wherein the separation portion is configured such that a time waveform acquired as the measurement apparatus irradiates the separation portion with a terahertz wave includes only a time waveform of a terahertz wave reflected by the first surface or such that a time difference between a time at which a terahertz wave reflected by the first surface is detected and a time at which a terahertz wave reflected by the third surface is detected is greater than a time difference between the time at which the terahertz wave reflected by the first surface is detected and a time at which a terahertz wave reflected by the second surface is detected.

12. The measurement apparatus according to claim 11, further comprising:
a changing unit configured to change an irradiation position of a terahertz wave from the irradiation unit.

13. The measurement apparatus according to claim 12,
wherein the changing unit is a support portion configured to support the plate-like member and the sample.

14. The measurement apparatus according to claim 11, further comprising:
an information acquisition unit configured to acquire information on the sample on the basis of the time waveform acquired by the acquisition unit; and
a forming unit configured to form an image of the sample on the basis of the information acquired by the information acquisition unit.

15. An information acquisition method for acquiring information on a sample, the information acquisition method comprising:
a first irradiation step of irradiating a sample with a terahertz wave through a plate-like member in a state in which the sample is disposed on a sample contact portion of the plate-like member;
a first detection step of detecting a terahertz wave reflected by at least one of the plate-like member and the sample;
a first waveform acquisition step of acquiring a first time waveform on the basis of a result of detection in the first detection step;
a second irradiation step of irradiating a separation portion of the plate-like member with a terahertz wave;
a second detection step of detecting a terahertz wave reflected by the plate-like member;
a second waveform acquisition step of acquiring a second time waveform on the basis of a result of detection in the second detection step; and
a first information acquisition step of acquiring information on the sample on the basis of the first time waveform and the second time waveform,
wherein the plate-like member includes:
the sample contact portion including a first surface and a second surface that is opposite to the first surface, the first surface being configured to receive a terahertz wave, the second surface being configured to come into contact with the sample when a measurement is carried out, and
a separation portion including the first surface and a third surface that is opposite to the first surface,
wherein the separation portion is configured such that a time waveform acquired as the measurement apparatus irradiates the separation portion with a terahertz wave includes only a time waveform of a terahertz wave reflected by the first surface or such that a time difference between a time at which a terahertz wave reflected by the first surface is detected and a time at which a terahertz wave reflected by the third surface is detected is greater than a time difference between the time at which the terahertz wave reflected by the first surface is detected and a time at which a terahertz wave reflected by the second surface is detected, and
wherein the information obtaining step includes:
a third waveform acquisition step of acquiring a third time waveform in which a time waveform of a terahertz wave reflected by the first surface of the plate-like member is subtracted from the first time waveform on the basis of the first time waveform and the second time waveform, and
a second information acquisition step of acquiring information on the sample on the basis of the first time waveform and the third time waveform.
